(19) United States
(12) Patent Application Publication
(10) Pub. No.: US 2010/0277321 A1
(43) Pub. Date: Nov. 4, 2010

(54) RFID Detection System and Methods for Enhanced Marketing

(75) Inventors: Tom McElwaine, Elyria, OH (US); Jay Gatz, Elyria, OH (US); Gary McDonald, Elyria, OH (US)

Correspondence Address: LOCKE LORD BISSELL & LIDDELL LLP, 600 TRAVIS STREET SUITE 2800, HOUSTON, TX, 77002-3095, US

(73) Assignee: EMERSON ELECTRIC CO., St. Louis, MO (US)

(21) Appl. No.: 12/826,492

(22) Filed: Jun. 29, 2010

Related U.S. Application Data
(62) Division of application No. 11/778,411, filed on Jul. 16, 2007.

(51) Int. Cl. G08B 13/14

(52) U.S. Cl. 340/572.1

(57) ABSTRACT

Systems and methods are disclosed for interactively marketing product information to an end user by monitoring the three-dimensional position of a radio-frequency identification (RFID) tag associated with an object within and around a merchandising display. The system includes a detector/reader incorporating circuitry for detecting changes in the three-dimensional position of an RFID tag from the detector/reader and for triggering the display of information relative to the product if a detected change in the three-dimensional “read zone” position is detected. The systems as described herein may be used to interactively display marketing material relative to a chosen object, or cross-sell related objects.

### CROSS REFERENCE TO RELATED APPLICATIONS

This application is a divisional application, and claims the benefit of, and U.S. application Ser. No. 11/778,411, filed Jul. 16, 2007, entitled “RFID DETECTION SYSTEM AND METHODS FOR ENHANCED MARKETING”. This application also claims the benefit of U.S. Provisional Application Ser. No. 60/830,786, filed Jul. 14, 2006. Both to of the above applications are incorporated herein by reference in their entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to the identification, monitoring, and marketing of consumer articles using radio frequency identification (RFID) technology, and more specifically, to the use of RFID systems and transponders (or “tags”) in position and location monitoring of consumer products retail environments. In particular, the use of RFID transponder systems for use with consumer products in marketing and cross-selling applications is disclosed.

2. Description of the Related Art

Product Identification using automated approaches, sometimes referred to as electronic article surveillance (“EAS”) systems, typically detect the presence of small electronic devices placed on or in an article or carried by a person of interest, and are often used in retail or library environments to deter theft or other unauthorized removal of articles. These devices, which are commonly known as ‘tags’ or ‘markers’, have evolved significantly over the years.

In the earliest approached, linear barcodes or magnetic stripes were used in EAS systems, but were limited in that they contained only information regarding the presence of an object. This information could be obtained by electronically interrogating the tag, either intermittently or continuously, using some form of machines capable of reading (‘readers’) the stripe or barcode. However, while generally having a high degree of read accuracy, these approaches suffered from the drawbacks of limited data capacity, and requiring line-of-sight or direct contact with the reader in order to extract the necessary data. Another alternative to conventional, linear barcodes are two-dimensional barcodes. These are two-dimensional symbols that are capable of encoding much more data than a conventional, linear barcode. However, these too suffered from requiring line-of-sight interaction with the reader in order to be useful. Another encoding device is the iButton®, a small token that stores information that can be read by a reader that makes electrical contact with the iButton®. Still other devices for storing information include printed and non-printed (e.g., etched) machine readable symbols (e.g., using a pattern recognition process) and digital watermarks.

Many users of EAS systems desire to know more than just whether a ‘tagged’ object is present. For example, they also want to know such information as which tagged object is present. Detailed information regarding the characteristics of objects, such as their date of manufacture, inventory status, and owner have generally been communicated to automated handling and control systems through an optical bar code such as described above. While inexpensive and effective, the optical bar code systems as described above have certain limitations. In example, bar codes must be visible, which limits the locations in which they may be placed, and bar codes can easily be obscured or marred, either accidentally or intentionally. Further, the range at which a detector or reader can sense the bar code is comparatively small, typically less than 0.5 meters, and the bar code often has to be appropriately positioned for detection, further limiting its utility. Additionally, because bar codes are often exposed to permit detection, the barcode is susceptible to damage that can result in detection failures. These constraints of bar code systems make them undesirable or inefficient for some applications, such as security applications, inventory control, or point-of-sale monitoring of objects.

In an effort to address the limitations of barcodes and magnetic stripes, at least four distinct types of EAS systems have evolved over the years, based on how this interrogation was carried out: magnetic, magnetomechanical, radio frequency, and microwave. Of these four, magnetic systems have often provided the highest level of security in most applications. Magnetic tags can be easily hidden in or on an object, are often difficult to defeat (because they are less susceptible to shielding, bending, and pressure), and are relatively easy to deactivate and reactivate, thereby providing a high degree of security and some information regarding the status of a tagged article.

More recently, electronic identification using radio frequency wave techniques (also known as radio frequency identification, or RFID) have been developed to address the limitations of optical barcodes and magnetic stripe systems. RFID systems have succeeded in providing object identification and tracking, but are deficient in providing object security because most RFID systems operate in frequency ranges (approx. 1 MHz and above) in which the tag is easily defeated. The security deficiency associated with some of the early radio frequency tags arises because they can be “shielded” by, for example, covering the tag with a hand or aluminum foil, or even placing the tag in a book. Even battery-powered radio frequency tags may be blocked, although their range is superior and blocking is significantly more difficult. Thus, objects tagged with an RFID tag may escape detection, either inadvertently or intentionally, greatly reducing their effectiveness as security devices. RFID markers may also be associated with “smart cards.” Both contact and “contactless” smart cards have appeared in commercial applications. Smart cards tend to be associated with a specific person rather than with a tagged object, and are often used in conjunction with the monitoring of types of purchases a consumer makes, such as what brands are preferred at a grocery store. Issues related to the security and tracking of the smart card (or of the person carrying it) are similar to those discussed above for RFID markers.

Since the advent of RFID, a variety of improvements and applications have been advanced in the art, with an associated rapid growth in applications of such radio frequency identification technology. These applications are as diverse as inventory management, point-of-sale monitoring, security detection, media (e.g., books and movies) checkout, and applications to the field of medicine including automated drug discovery, microarrays, combinatorial chemistry, and blood bank applications, wherein RFID technology has been used to assist in the management and tracking of blood, allowing for improved safety and improved tracking and delivery services. Commercial applications of RFID technology has even included using tags embedded in plastic nails, allowing a forestry company to tracks logs as they move from the forest to the factory.

For example, U.S. Pat. No. 6,681,989 offers a system and method for allowing a consumer to make a purchase within a retail area and then remove that purchased item from the retail area without causing an alarm to sound, using an EAS system. The system describes itself as capable of identifying both the customer and the product to be purchased by that customer, validating the selected item, and then posting the transaction to the customer's account. Thereafter, the system commands the EAS to allow removal of the purchased item from the secure, retail area. Customer identity and product identity are by RFID tags which links to an associated RFID terminal which acts as the customer and product “consumer identification unit”.

A separate use for RFID systems has been described in U.S. Pat. No. 6,681,990, assigned to SAP Aktiengesellschaft. This patent suggests methods and apparatus for real-time inventory management and control. According to the specification and claims, the apparatus includes a monitoring system having a tag reader configured to read tags (e.g., RFID tags) from tagged items within an inventory, means for detecting and reporting that an item has been added to or removed from inventory, and one or more associated tracking systems.

U.S. Pat. No. 6,577,238 offers an RFID detection system for use in monitoring the position of one or a plurality of RFID tags on a product. According to the specification, the system is made up of a detector incorporating specific circuitry which is capable of detecting changes in the range of an RFID tag from the detector, and for triggering an appropriate alarm should the detected range exceed a predetermined threshold, or if the RFID radio tag can no longer be detected by the detector (e.g., in the event that it is hidden).

Applications of RFID technology are not limited to security and consumer product tracking and monitoring alone. Encoding techniques for use in combinatorial chemistry and biological evaluation in drug discovery, such as the IRORI Rf tags for use with their micro-reactors (MicroKans™) has been described previously (Czarnik, A. W., “Encoding Strategies in Combinatorial Chemistry”, Proc. Natl. Acad. Sci., USA, Vol. 94 (1997); pp. 12738-12739). Related U.S. Pat. No. 6,136,274 suggests automated drug discovery protocols in which matrices-with-memories, based on the use of radio frequency identification tags embedded in the platform, serve as repositories of all the information transferred during the synthesis and screening of potentially biologically active compounds.

U.S. Pat. No. 6,676,014 to Catan suggests a variety of options relating to an RFID label tagging system linked to a network and internet connections. As described therein, the system goes beyond simple information-gathering and exploits both context information and search engine technology using natural search language to enable user searches, creation, and maintenance of resource bases. Numerous applications are offered, including scanning a chosen retail food article and obtaining recipes that include that food article, requesting specific information via the Internet related to a user-chosen article that is scanned-in at a terminal, and using the information from the scanned article(s) to transmit messages (e.g., specials, coupons or catalogs) to the user by a variety of delivery options.

More recently, U.S. Pat. No. 7,195,159 has described methods, systems, and apparatus for tracking items automatically in an airport environment. The system describes the use of passive (e.g., non-battery) RFID tags attached directly to aviation assets, with antennas placed at locations where monitoring of assets is necessary. A local controller and RFID reader use the antennas to communicate with the passive RFID tags in order to determine the identity and location of the assets.

To date, however, there have not been any RFID systems useful in the marketing arena, allowing for delivery of supplemental product information, product cross-selling, and the like. This is due to the fact that, in general, use of RFID in retail environments is difficult for a number of reasons, one or more of which may be at play in any specific retail environment. For example, it is often the case that there is a high steel content in the building and in the floor (e.g., steel rebar in the concrete floor), which can cause numerous difficulties in using RFID technology due to radio frequency signal absorption. Other problems encountered in the retail market that can limit or restrict the use of RFID are the combination of narrow aisles which result in signal disruption from adjacent displays (sometimes referred to as store merchandising constraints) and problems in signal read accuracy, as well as consistency problems with the “read zone”—the area of the display from which products may be identified. Other contributors to the difficulties of RFID application in such commercial retail environments are tag orientation issues, cost and operation concerns, and signal disruption or reflection from products having a metallic content. Thus, there exists a need for methods and systems of monitoring products in a retail environment so as to quickly provide a customer with marketing information specifically directed to the product they have chosen.

The inventions disclosed and taught herein are directed to systems, methods, and assemblies for identifying and automatically providing marketing information about consumer products in retain environments, upon their selection by a consumer.

### BRIEF SUMMARY OF THE INVENTION

The present disclosure describes methods, systems, and assemblies for use in the interactive marketing of product information to an end user by monitoring the three-dimensional position of a radio-frequency identification (RFID) tag associated with the product. In accordance with an embodiment of the present disclosure, systems for the interactive marketing of a product in a retail environment are described, wherein the system comprises a merchandise display; an RFID (radio frequency identification) tag associated with an object; an RFID antenna, RFID reader, or combination thereof; a detector incorporating means for receiving signals from the RFID tag and capable of detecting changes in the position of the RFID tag from the detector and simultaneously defining a positional zone related to the object associated with the RFID tag; and display means for displaying information related to the object, wherein the RFID antenna, RFID reader, or combination thereof shape an RFID read zone. In further accordance with this embodiment of the disclosure, one or more of the antenna, reader, detector, and RFID tag are GEN-2 compliant.

In accordance with further embodiments of the present disclosure, systems for monitoring the position of an object within a predefined zone for the purpose of interactive marketing a commercial product are described, the system comprising a transmitter for transmitting radiofrequency (RF) energy; a radio frequency identification (RFID) tag comprising an RFID chip, an antenna, and integrated antenna-to-chip connection, and circuitry for receiving the RF energy from the transmitter; a detector for receiving regular transmission of bursts of transmitted RF energy from the RFID tag; and a display means for displaying interactive marketing material related to a specific object. In further accordance with this embodiment of the disclosure, one or more of the antenna, reader, detector, and RFID tag are GEN-2 compliant.

In yet further embodiments of the present disclosure, methods for conveying interactive marketing information to an individual consumer are described, wherein the conveying uses the position of an RFID tag associated with an object to convey the information. Such methods comprise, generally, transmitting RF energy to the RFID tag associated with the object; receiving the RF energy in the RFID tag through an antenna means; transmitting RF energy from the RFID tag to a detector; detecting the transmitted RF energy from the RFID tag and determining a change in three-dimensional position of the RFID tag; and, prompting an interactive informational display of information related to object if the three-dimensional position of the RFID tag exceeds its predetermined three-dimensional location.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIGS. 1A-1E illustrate schematic representation of radio frequency identification tags which may be used in accordance with the present disclosure.

FIG. 2A illustrates an embodiment of the present disclosure, wherein an RFID tag is associated with a product through a tag on the product packaging.

FIG. 2B illustrates an embodiment of the present disclosure wherein an RFID tag is associated with a product by direct attachment to the product.

FIG. 3A illustrates an embodiment of the RFID system of the present disclosure, illustrating interactive marketing in a retail environment.

FIG. 3B illustrates a side view of the system of FIG. 3A.

FIG. 3C illustrates an alternative RFID system in a retain environment, in accordance with aspects of the present disclosure.

FIG. 4 is a block diagram of the basic structure of an embodiment of the present disclosure, illustrating an RFID tag interacting with an RFID interrogation system.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of the present invention.

As used herein, the term “antenna” refers to the RFID tag antenna, which is the conductive element that enables the tag to send and receive data. In particular, the term “antenna” used herein refers to passive antenna, suitable for use with passive, low- (135 kHz) and high-frequency (13.56 MHz) tags which typically have a coiled (or similar) antenna that couples with the antenna of an associated reader to form a magnetic field. Readers also have antennas which are used to emit radio waves. The RF energy from the reader antenna is “harvested” by the antenna and used to power up a microchip, which then changes the electrical load on the antenna to reflect back its own signals.

The term “RFID Tag”, or “tag”, as used herein, refers to any one of a number of UHF (ultra-high frequency, ranging from about 300 MHz to about 3 GHz, as well as RFID tags that operate between about 860 MHz to about 960 MHz) microchips attached to an antenna that is packaged in a way that it can be applied to an object. The tag typically picks up signals from and sends signals to a reader. As used herein, the tag may contain a unique serial number, but may have other information, such as a customers' account number. Tags may come in many forms, such as smart labels that can have a barcode printed on it, or the tag can simply be mounted inside a carton, embedded in plastic, or attached in other known methods. RFID tags suitable for use herein can be active, passive or semi-passive, as appropriate.

The term “reader” or “RFID reader”, as used herein, refers to a device used to communicate with RFID tags. The reader typically has one or more antennas, which emit radio waves and receive signals back from the tag. The reader may also be referred to as an interrogator because it “interrogates” the tag.

The term “Passive Tag”, as used herein, refers to an RFID Tag without its own power source and transmitter. When radio waves from the reader reach the chip's antenna, the energy can be converted by the antenna into electricity that can power up the microchip in the tag. The tag is able to send back information stored on the chip. The amount of information capable of being manipulated on passive tags may range from about 64 bits to 2 kilobytes or more.

The term “Gen 2”, as used herein, refers to Electronic Product Code (EPC) Generation 2, the standard ratified by EPCGlobal for the air-interface protocol for the second generation of EPC technologies.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

The present invention relates to RFID tags for use in interactive marketing. As specifically described herein, the present invention comprises systems and methods for the interactive marketing of commercial products, wherein the system monitors the position of at least one radio frequency identification (RFID) tag associated with a product in a defined, three-dimensional space. The system comprises a merchandising display or the equivalent, at least one RFID tag associated with an object, wherein the RFID tag transmits radio frequency (RF) energy, an RFID antenna and reader capable of providing an enhanced “read zone”, and at least one detector incorporating means for receiving signals from the RFID tag for the purpose of detecting changes in the position of the RFID tag from the detector and simultaneously defining a positional zone related to the object associated with the RFID tag. The system also preferably includes a display means for displaying information related to the object, such as more detailed information about the object, applications for use of the object, proper use and handling of the object, printable instructions/information related to the object, and objects and/or accessories related to the object, as well as their locations.

The Radio Frequency-Responsive Elements

RFID tags suitable for use with the present invention can be either active or passive tags. An active tag incorporates an additional energy source, such as a battery, into the tag construction. This energy source permits active RFID tags to create and transmit strong response signals even in regions where the interrogating radio frequency field is weak, and thus an active RFID tag can be detected at greater range. However, the relatively short lifetime of the battery limits the useful life of the tag. In addition, the battery adds to the size and cost of the tag. A passive tag derives the energy needed to power the tag from the interrogating radio frequency field, and uses that energy to transmit response codes by modulating the impedance the antenna presents to the interrogating field, thereby modulating the signal reflected back to the reader antenna Passive tags are preferably used in accordance with the aspects of the present disclosure, although those of skill in the art will recognize that both active and passive tags may be used with these inventions.

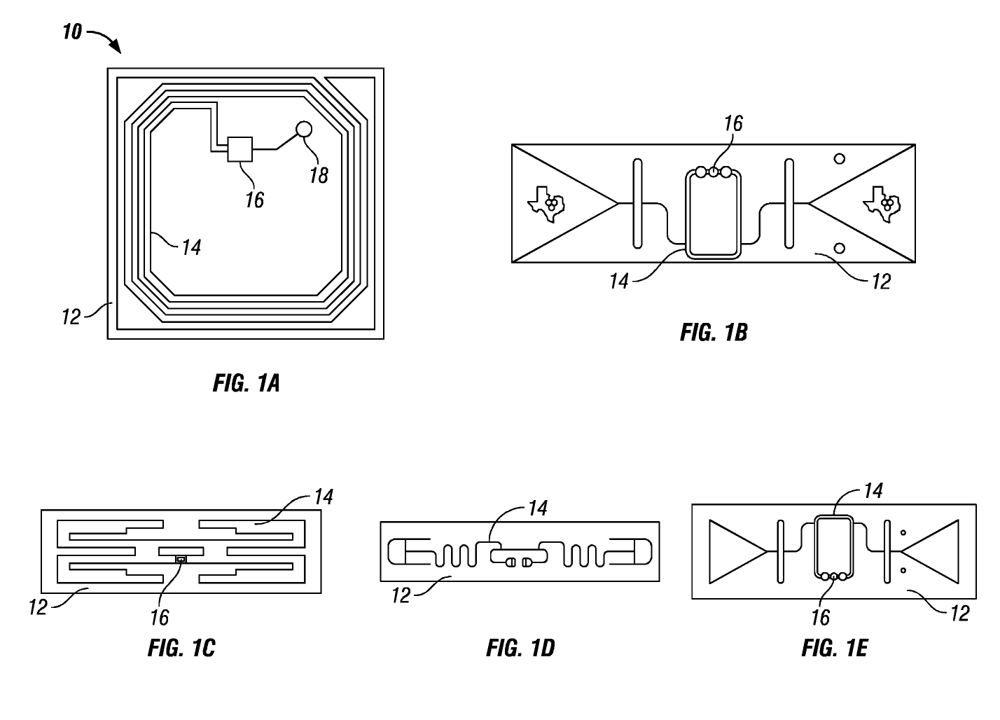

As shown in FIGS. 1A-1E, a plurality of exemplary UHF radio frequency ID tags suitable for use with the present invention are illustrated. With specific reference to FIG. 1A (although the same analysis refers to all of the tags illustrated in FIG. 1), the UHF RFID tags suitable for use with the present disclosure are preferably, but not necessarily, GEN2 tags, comprising a radio frequency identification element 10 that is typically mounted or attached (using any number of suitable attachment means) to a suitable substrate 12, which may be planar as illustrated in the Figure, and in keeping with the present disclosure includes several key components: an antenna 14, an integrated circuit chip 16 and an antenna/chip connection 18. The integrated circuit (IC) chip typically provides the primary identification function. It may includes software and circuitry to permanently store the tag identification and other desirable information, interpret and process commands received from the interrogation hardware, respond to requests for information by the interrogator, and assist the hardware in resolving conflicts resulting from multiple tags responding to interrogation simultaneously. Optionally, the integrated circuit chip may provide for updating the information stored in its memory (read/write) as opposed to just reading the information out (read only). Integrated circuits (IC) suitable for use in the RFID marketing systems as described herein include but are not limited to those available from Alien Technology Corporation (Morgan Hill, Calif.), such as the SQUIGGLE™, MINI-SQUIGGLE™, and OMNI-SQUIGGLE™ products; Texas Instruments (Dallas, Tex.), such as their TI DALLAS® product; and Precisia/RF IDentics (Grand Rapids, Mich.), such as their FlexWing™, MaxWing™, MidWing™, SmallRound™, CD ILT™, and PROPELLER™ products, among others. Additionally, the RFID tags suitable for use with the present disclosure are capable of operating at frequencies ranging from between about 300 MHz to about 3 GHz, more preferably ranging from about 800 MHz to about 1,000 MHz, including ranges between these two values, such as from about 860 MHz to about 980 MHz, inclusive and without limitation.

The antenna 14 suitable for use with the present disclosure has a geometry and properties dependant upon the desired operating frequency of the RFID portion of the tag. For example, 2.45 GHz (or similar) RFID tags could include a dipole antenna, or a folded dipole antennas. A 13.56 MHz (or similar) RFID tag would use a spiral or coil antenna 14, as shown attached to the radio frequency responsive element 10 in FIG. 1. In either case, the antenna 14 intercepts the radio frequency energy radiated by an interrogation source. This signal energy carries both power and commands to the tag. The antenna enables the RF-responsive element to absorb energy sufficient to power the IC chip and thereby provide the response to be detected. Thus, the characteristics of the antenna must be matched to the system in which it is incorporated. In the case of tags operating in the high MHz to GHz range, the most important characteristic is the antenna length. Typically, the effective length of a dipole antenna is selected so that it is close to a half wavelength or multiple half wavelength of the interrogation signal. In the case of tags operating in the low to mid MHz region (13.56 MHz, for example) where a half wavelength antenna is impractical due to size limitations, the important characteristics are antenna inductance and the number of turns on the antenna coil. For both antenna types, good electrical conductivity is required. Typically, metals such as copper or aluminum would be used, but other conductors, including magnetic metals such as permalloy, are also acceptable and are, in fact, preferred for purposes of this invention. It is also important that the input impedance of the selected IC chip match the impedance of the antenna for maximum energy transfer. Additional information about antennas is known to those of ordinary skill in the art from, for example, reference texts such as J. D. Kraus, “Antennas” (3rd ed. 2001, McGraw-Hill, Inc., New York).

A capacitor may optionally be included on chip 10 in order to increase the performance of the tag. Such a capacitor, when present, operates to tune the operating frequency of the tag to a particular value. This is desirable for obtaining maximum operating range and insuring compliance with regulatory requirements. The capacitor may either be a discrete component, or integrated into the antenna. In some tag designs, particularly tags designed to operate at very high frequencies, such as 2.45 GHz, a tuning capacitor is not required. The capacitor is selected so that, when coupled to the inductance provided by the antenna, the resonant frequency of the composite structure, given by:

$${f}_{r} = ( \frac{1}{2 π} ) \sqrt{\frac{1}{LC}}$$

where
C=capacitance (in Farads), and
L=inductance (in Henries) and closely matches the desired operating frequency of the RFID system. The capacitor may also be a distributed capacitor. Distributed capacitance is desirable to reduce tag size, particularly thickness, and to minimize manual assembly.

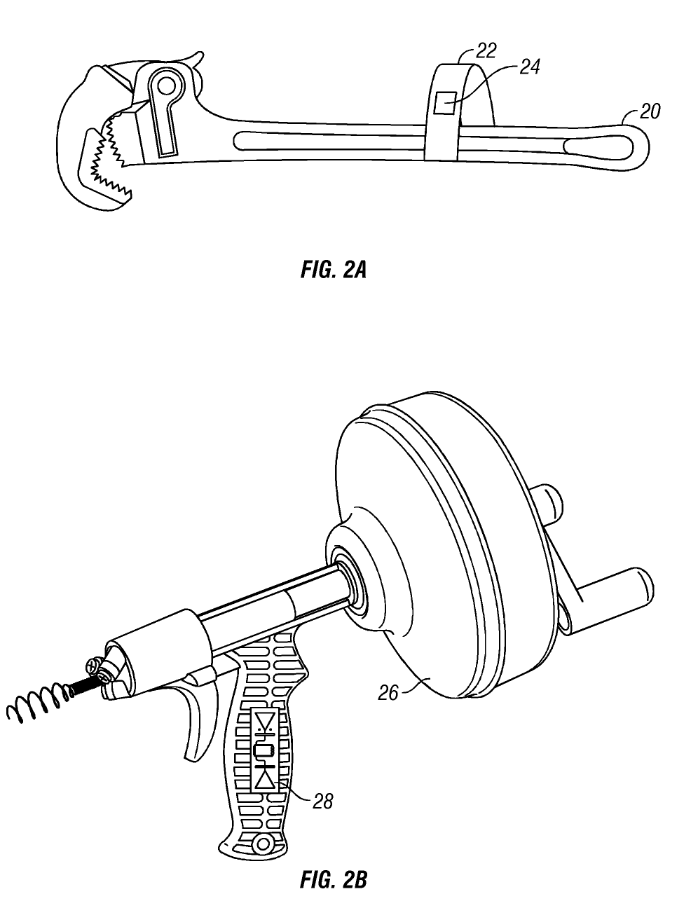

The RFID tags as described above can be attached or associated with a product or object in numerous ways known to those of skill in the art. In accordance with the present disclosure, and as specifically illustrated in FIG. 2A, a pipe wrench (or similar article) 20 may have a packaging identification tag 22 which typically has on or associated with it a line barcode for use in product purchase, inventory control, and the like. RFID tag 24 may be easily attached to tag 22 using any number of suitable attachment means, including but not limited to adhesives and sealants. Consequently, when an article such as wrench 20 is placed on a merchandising display rack in a retail environment, RFID tag 24 can receive and transmit radio frequency (RF) energy to a detector/reader located proximal to the object, thereby contributing to the defining of a three-dimensional space, or “read zone”, around wrench 20. Any movement of the wrench outside of an active “read zone” is typically monitored by a change in RF energy transmitted from the RFID tag 24 via its antenna, allowing for the system of the present invention to be activated.

FIG. 2B illustrates another aspect of the present disclosure, wherein an article for purchase by a consumer may be labeled with an RFID tag directly. As illustrated therein, a drain tool 26 which is suitable for display in a merchandising unit and RFID marketing system as described herein may have an RFID tag 28 directly adhered onto a portion of its surface, separate and distinct from any other product tracking, security, or identification devices. Other RFID tags suitable for use with the systems and methods of the present disclosure include, but are not limited to, printed RFID tags, wherein the entire circuit is printed on a flexible substrate, such as a paper label or the like, in a roll-to-roll process or the equivalent. Printed RFID tags may be desirable for use with the present disclosure due to their size, profile, and/or physical flexibility characteristics

Merchandising System

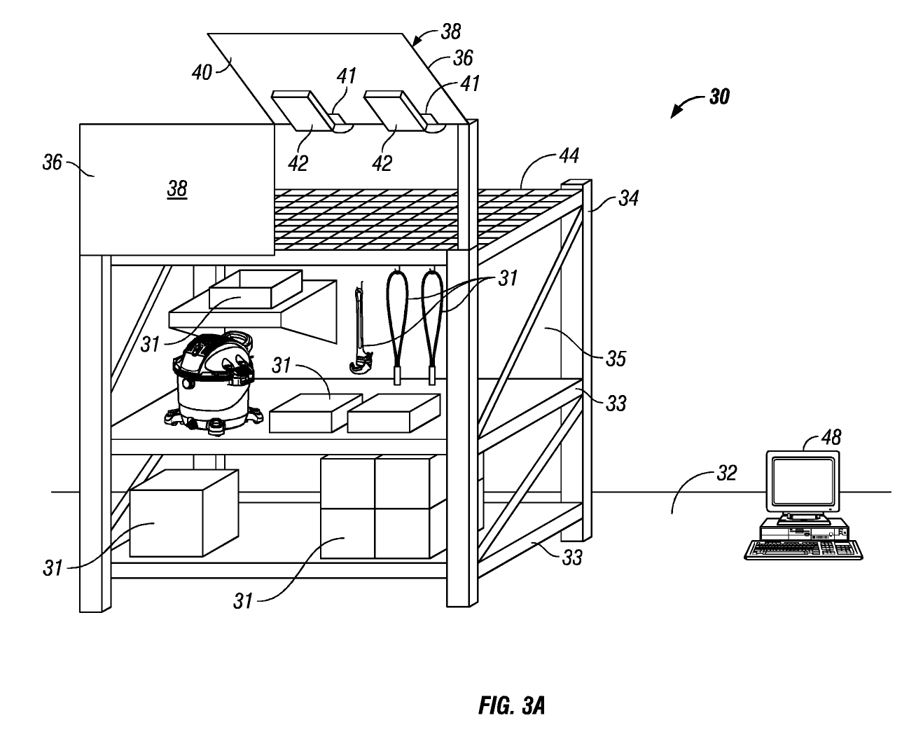

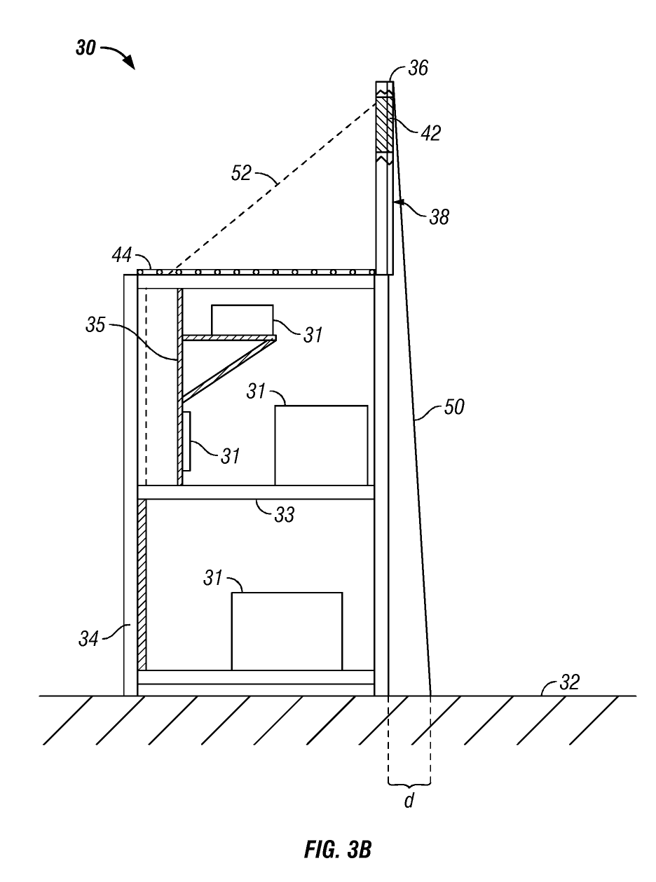

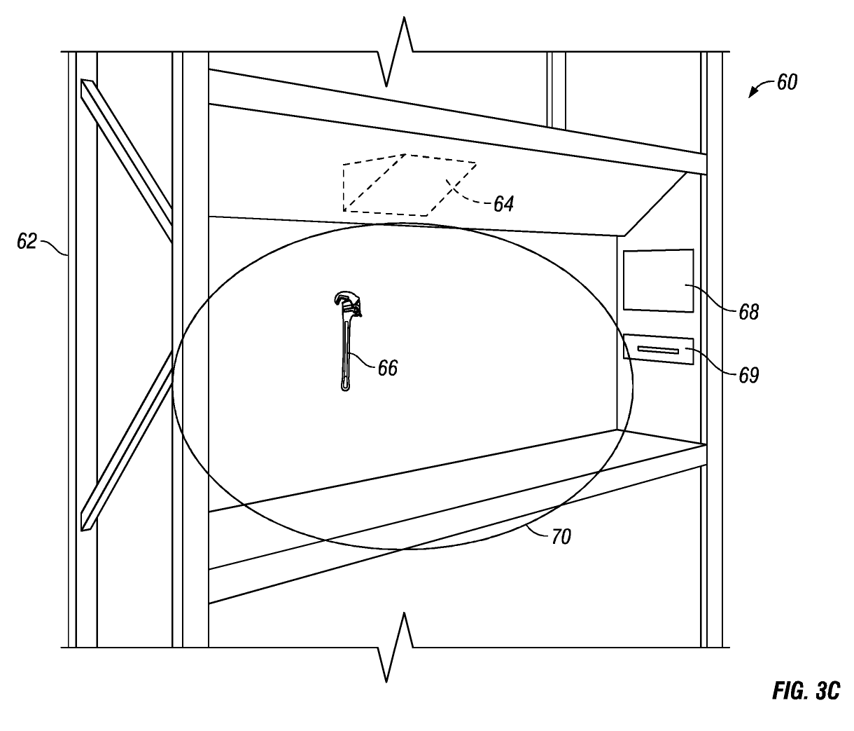

FIG. 3A illustrates an exemplary merchandising system 30 for use with RFID tags in the marketing of products within a retail environment, track inventory, and/or track product shelf movement. The system 30 comprises a merchandising display assembly 34, which is typically constructed primarily of metal, but may also be constructed of a variety of different materials, as appropriate for the retail location. Display assembly 34 is typically situated (in retail environments such as warehouse clubs and similar merchandising environments) on a surface 32, wherein the surface comprises metal support materials therein (e.g., rebar). In accordance with the present disclosure, the assemblies and methods disclosed herein are especially advantageous in retail environments wherein greater than about 50% of the area surrounding the merchandising system are reflection to radio signals and frequencies, and/or are capable of causing problems with radio frequency signal absorption. Display assembly 34 may be of any appropriate shape, so long as it comprises at least a side (in the case of a substantially circular display) and a top portion, and may comprise one or more display shelves 33, a display wall 35, one or more overhead signage doors 36 having a front face 38 suitable for advertising messages, one or more antenna/reader control boxes 42 comprising an RFID antenna and an RFID reader, and/or an RFID detector, and hardware cloth or similar material 44 which substantially covers the top of the merchandising display 34. If the optional RFID detector is included in the system for the interactive marketing of a product in a retail environment, such a detector may be included within the box 42 comprising the antenna and reader, or may be attached to display 32 separately, as appropriate. Articles 31 to be displayed for retail sale to a consumer may be located on shelves 33 within the merchandising display 34, or may be hung and displayed by any appropriate display means (e.g., hooks) on a display wall 35 within the display itself. The merchandising system 30 also preferably comprises one or more associated CPU display systems 48, and associated hardware, which is capable of being in communication (directly or indirectly) with the RFID tag reader, and which may provide a variety of marketing-related information to the customer concerning a specific product. The systems described herein may also include one or more controllers (not shown) for managing the communications interface. The host display system (i.e., computer) 48 can interface with the controllers and direct the interrogation of the RFID tags disposed on or adhered to the articles 31 within display 32. Further, the CPU display system 48 may also be an object management system (OMS) or the equivalent, capable of receiving information regarding read tags from the reader, e.g., as the tagged article crosses the “read zone” and transmits data to the reader, antenna, and/or detector, and storing this information as appropriate or desired.

The antenna/RFID reader control boxes 42 comprising RFID antenna and readers (hereinafter referred to as antenna/reader 42), as well as the optional detector if included, may be mounted anywhere appropriate within or surrounding the merchandising display 34. As illustrated in FIG. 3A, however, they are preferably affixed under and behind the overhead signage door 36, such as on backside 40 of door 36, using hinge assemblies 41. Hinge assemblies 41 may be any suitable hinge assembly, but preferably, they act as both a hinge for the raising and lowering of the signage door 36, as well as a mounting bracket for the reader control boxes 42 comprising the antenna/RFID readers. Suitable RFID readers or reader/antenna combinations 42 suitable for use with the present disclosure include but are not limited to those systems available from Alien Technologies Corp. (Morgan Hill, Calif.); Thing Magic (Cambridge, Mass.), including their Mercury series of readers and antennas; SAMS ys Technologies, Inc. (now Sirit Inc., Carrollton, Tex.); and Symbol®, including their AN 200 General Purpose RFID antennas and their XR440 and XR480 readers. Preferably, in accordance with the present disclosure, the antenna and readers are paired in a match set, for optimal performance. It has advantageously been found that antenna and readers, in paired sets, provide an enhanced performance and RFID “read zone” associated with the merchandising display 34. Further, the use of pairs of antenna allows for them to work in an alternating fashion of transmitting and receiving, which in turn aids in increasing the reliability of reading tags in the active “read zone” to greater than 90%. UHF RFID antenna suitable for use herein have read ranges ranging from about 0.6 inches to about 20 feet (6 m), as well as ranges in between these two values (e.g., about 4 feet, about 6 feet, about 8 feet, and about 10 feet). Additionally, the number of antenna and readers for use with the systems of the present disclosure may range from one to more than twenty, including two, three, four, five, six, eight, ten, twelve, fourteen, sixteen, eighteen, and twenty, as well as numbers between one and twenty not listed herein.

The optional inclusion of hardware cloth 44 (or the equivalent) across a substantial portion (e.g., greater than about 60%) of the top of the merchandising bay defined by the display 34 was found to assist in both the “read zone” shaping and control. In effect, the inclusion of the hardware cloth 44 across substantially the entire top of merchandising display 34 acts as a shield and “tricks” or directs the antenna (housed within 42) into seeing only into the aisle space extending a distance d in front of the merchandiser (see, FIG. 3B), and in this manner containing or directing the RFID field outside the display while maintaining a desired level of transparency, if appropriate. Hardware cloth 44 may be woven or welded, and may be steel, stainless steel, galvanized metal, aluminum, brass, bronze, copper, zinc, RFI shielded material, or any other appropriate material, including appropriately coated fiber and glass-fiber mats, which will aid in shaping the controlling the “read zone” of the present system. Hardware cloth 44 may have a number of holes, or mesh openings, the diameter of which may be dictated by the frequency of the RFID field being used. In accordance with aspects of the present disclosure, cloth 44 may have a mesh size ranging from 1-inch mesh (the wires are one-inch apart, center-to-center) to 8-inch mesh (the wires are ⅛-inch apart, center-to-center), including but not limited to 2-mesh (wires are ½-inch apart, center-to-center), 3-mesh (wires are ⅓-inch apart, center-to-center), 4-mesh (wires are ¼-inch apart, center-to-center), and 5-mesh (wires are ⅕ of an inch apart, center-to-center).

FIG. 3B illustrates a side profile of the system 30 illustrated in FIG. 3A, demonstrating a controlled “read zone” produced by the system of the present disclosure. As can be seen in the figure, the combination of selected antennas and readers in housing 42, and locating of the combination reader and antenna housing 42 near the top of the overhead signage door 36, in conjunction with the use of hardware cloth 44 (across substantially the entire top of the merchandising bay of display 34) allows for the controlled shaping of the “read zone” (sometimes referred to in the art as the “interrogation zone”) 50—the three-dimensional RF coverage area, the volume inside of which the antennas and readers can communicate with the transponders (RFID tags). In accordance with some non-limiting instances of the present disclosure, the “read zone” may be defined by the effective RF radiation or electro-magnetic field component. As illustrated in the figure, in accordance with this aspect of the disclosure, the “read zone” 50 has a curtain effect that falls substantially directly over the front of merchandising display 34, thereby eliminating the undesired reading of all the shelf inventory products 31. In accordance with this disclosed aspect of the invention, the “read zone” 50 may also extend a distance d outside and away from the front of display 34, a distance which may be controlled as desired by adjusting parameters and/or location of the antennas and readers within housing 42, as well as by the inclusion or characteristics of hardware cloth 44. The distance d may range from about 0.01 inches to about 40 feet, and more preferably from about 0.01 inches to about 20 feet outside and away from the front of display 34, including but not limited to about 0.5 inches, about 1 inch, about 6 inches, about 1 foot, about 5 feet, about 10 feet, and about 20 feet, as well as distances between any of these recited distances, e.g., about 6.5 feet, or about 12 feet.

Optionally, and equally acceptable, depending upon the location and construction materials of merchandising display 34, it may not be necessary or desirable to eliminate the option of reading the RFID tags of all the shelf inventory 31, in which case adjustment of the location of the antenna/readers 42 and removal of at least a portion of the hardware cloth 44 can generate an optionally expanded “read zone” 52 that allows the antenna/reader 42 to see into the merchandising bay of the merchandising display, as well as into the aisle space in front of the merchandiser.

In accordance with specific aspects of the present disclosure, and as a non-limiting example of a use the system of FIG. 3A, as the merchandising display 34 sits static, the display screen of the CPU system 48 associated with the display 34 can sit idle, or can display marketing messages on its display screen, so as to create noise in the environment of merchandising display 34, thereby attracting customer's attention. Once a customer approaches the display 34, makes a selection of an article 31 from a shelf 33. As the article 31 breaks the boundaries of the “read curtain” 5, the antenna 42 detects the tag 24/28 associated with the object 31, and begins to count the reads on the tag 24/28 using a reader. The CPU 48 which is in communication with the reader cues the next series of activities, and proceeds to display additional product information and messaging to the customer. Such display information may be any variation of market information or content mediums, which will be based upon user discretion as well as the particular hardware and/or software installed in the CPU and associated systems. The CPU system 48 may be either embedded or attached to the merchandising display 32, or may be located in proximity to the display itself, and may be configured to receive input data that identifies the object within the display when the object is removed from the display and passes through a read zone. In the instance that the CPU system 48 is proximately located to the display 32, the system (and any associated computers and/or processors) may be coupled to the merchandise display by way of Ethernet, wireless, optical infrared, serial cable, or USB cable data connection means, as well as combinations of such data connection means.

FIG. 3C illustrates an alternative embodiment of the system shown in FIGS. 3A-3B, wherein an interactive retail merchandising display 60 is similarly shown. The display 60 comprises a merchandising display assembly 62 that comprises a merchandizing bay therein wherein products, such as consumer object 66, are displayed for purchase and/or examination by a customer, an RFID reader/detector 64, a product information display means 68, and an information retrieval means 69. The system of FIG. 3C differs from that illustrated in FIGS. 3A-3B in that this system comprises a product information display 68 directly associated with the display assembly 62, and the RFID reader/detector(s) 64 may be mounted directly above the merchandizing bay. RFID reader/detector 64 may be linked to an appropriate software/hardware system and associated architecture (not shown). Retail object 66 has attached to it an RFID tag (not shown), as described above, which both transmits and receives RF energy to and from the RFID reader/detector 64, which is preferably mounted in a location not readily observable to the user/consumer.

In an exemplary embodiment of the present invention, and as described above, retail object 66 has an associated RFID tag, which transmits and receives RF energy from one or more RF reader/detectors 64. This RF energy serves to allow reader/detector 64 to define a three-dimensional location for object 66 within display assembly 62. Upon removal of retail object 66 from its display location (e.g., the user picks it up to examine it), the RF energy transmitted from the object 66 to reader/detector 64 triggers the detector 64 to determine the change in the three-dimensional location of the object 66. That is, the detector 64 is capable of tracking the product as it moves around, in, out, and through the three-dimensional “read zone” 70, which includes the area within the merchandising bay itself, as well as a region partially outside of, and preferably in front of, the display assembly 62. Similar to the system illustrated in FIGS. 3A-3B, once the object 66 selected by a consumer is moved a predetermined distance within, or breaks the boundaries of, the “read curtain” or “read zone”, 70, the antenna with the detector 64 detects the tag and starts to count the reads on that tag, via an appropriate RFID reader, such as described above. A signal may then sent, via any number of known transmission means known in the art, to a CPU that is in (direct or indirect) communication with the tag reader, and which processes the unique identifying information from the RFID tag of the object 66 and cues display means 68 to provide the appropriate and/or desired product information and messaging to the customer. Optionally, and equally acceptable, the system may be initiated by the user scanning the tag in front of a RFID reader located in, on, or near the merchandising bay of display assembly 62, such user-induced action similarly triggering the display of marketing and product information.

Display means 68 can be any number of known audio, visual, or a combination audio/visual display known in the art. In accordance with certain aspects of the present disclosure, display means 68 may be interactive with the user, in that they may include touch-screen options such as comparison buttons, part selection for the object being viewed, and the like. Such display means 68 suitable for use with the present invention include but are not limited to video monitors, audio speakers, touch-screen displays, and the like. Upon receipt of the signal from detector 64, display means 68 can begin to transmit or display information related to the selected object 66 to the consumer. The information associated with each product may be stored, as appropriate, in the display, in the RFID tag itself, or in a CPU system that correlates the information with the RFID tag when the tag is activated. Such transmitted information can include, but is not limited to, recorded information; visual information, such as pictures or movies of the product; associated tools related to the object; key features of the product; applications of the product; proper use of the product; user manuals; part number re-order lists and associated information; product count information; inventory information; pricing information; and related products and/or accessories that the user might be interested in (the latter information known as “cross-selling information”).

The user can then choose from a variety of options, including having the displayed information printed via an appropriate printing means 69, which can be any number of known and suitable printing means known in the art. Preferably, both display means 68 and printing means 69 are conspicuously located relative to the displayed products. Such locations can include within the same display (as shown in FIG. 3C), or in a nearby, remote information kiosk (such as illustrated in FIG. 3A).

Operation

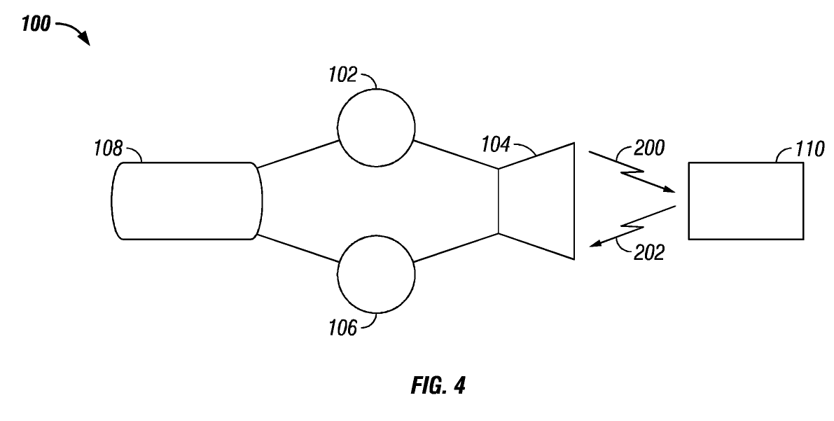

In operation, as illustrated in the flow-chart of FIG. 4, in typical operation, the radio frequency-responsive tag 110 associated with a product for sale in a marketing environment is interrogated by an RFID monitoring system 100, which is typically located near the point at which the tags are to be monitored. A three-dimensional interrogation zone can be established by placing spaced detection panels across the product display, directly over the product display, near a conveyor carrying items to be monitored, near a product or object to be monitored, or the like. While not described in explicit detail herein, it is envisioned that hand held detection devices can also be used in connection with embodiments of the present invention. An interrogation source 102 (typically including a drive oscillator and an amplifier) may be coupled to an antenna 104 (sometimes described as a field coil) for transmitting an alternating radio frequency field, or interrogation signal, in the interrogation zone. The system 100 can also include an antenna for receiving a signal (shown as antenna 104, and sometimes described as a receiving coil or reader) and detector 106 for processing signals produced by tags in the interrogation zone.

The interrogation source 102 transmits an interrogation signal 200, which may be selected within certain known frequency bands (e.g., 860 MHz to 980 MHz) that are preferred because they do not interfere with other applications, and because they comply with applicable government regulations. Preferably, and in accordance with the present invention, the interrogation signal 200, and the response code signal 202, are radio frequency (RF) energy signals. When the radio frequency-responsive element receives an interrogation signal it transmits its own response code signal 202 that is received by the antenna 104 and transmitted to detector 106. The detector decodes the response, identifies the tag (typically based on information stored in a computer or other memory device 108), and takes action based on the code signal detected. Various modifications of the illustrated system are known to those of skill in the art including, for example, using separate antennas for the interrogation source 102 and the detector 106 in place of the single antenna 104 that is illustrated.

In accordance with the present invention, the action taken based upon the signal code detected is the initiation of an interactive display means, such as described above. Such display means serve to provide, based upon the information supplied by the RFID tag on or associated with the product, information directly related to the object which has transmitted RF energy signals to the detector and/or reader. This information can include, but is not limited to, key features of the object; applications of the product (e.g., uses, or recipes in the case of food products); proper use and handling of the object (e.g., safety information); printable instructions; related objects associated with the chosen object which the user may find helpful or useful (cross-selling information); number-count information; and combinations of such information.

The systems and methods of operation described herein illustrate that RFID technology, especially that technology comprising GEN-2 RFID components, can be used in retail settings (especially those having greater than 50% of their structure comprising metal such that the structure of the retail environment itself can interfere with the use of standard, earlier-known RFID systems), as interactive marketing tools, and potentially as future inventory control monitors. While the use of RFID in any capacity within warehouse-type and Point-of-Sale retail environments can be difficult, for the reasons outlined above, the present systems and methods allow for the sales, marketing, and/or inventory opportunities as of yet untapped.

Numerous alternative embodiments based on the above-described RFID system are envisioned, other than marketing directed cross-selling applications. For example, it is envisioned that a similar RFID system could be utilized in gym settings to keep track of the users settings and preferences with regard to gym equipment. An RFID tag, such as described above, could be provided to the individual through the commonly-issued gym identification card, a key chain fob, or article having an RFID tag device incorporated therein. As a user approaches a piece of gym equipment in preparation for use, such as a stepping apparatus, the RFID tag emits a radio frequency energy signal which is received by a detector associated with the gym equipment. Such detection triggers retrieval of user information (e.g., machine settings, times, preferences, heights, degrees of resistance, and the like), which is then directed to the gym equipment. The gym equipment thereby ‘sets’ the programmable settings to the users saved/stored information, allowing the gym user to immediately begin using the apparatus without having to remember what settings they have, or waste time re-setting the apparatus to their desired settings.

Similar applications of the RFID system as described herein can also be used in a variety of other embodiments, including but not limited to pet food and water monitoring (e.g., an RFID tag on the pet collar could allow for dispensing of food at prescribed times, or when the animal approaches the food or water bowl); monitoring storage tanks, compressors, and similar equipment for maintenance and frequency of use; and automatic adjustment of a car's seats and mirrors in the instance of a single car having numerous drivers. In this latter alternative embodiment, an R ID tag located within a keychain fob could allow the car to begin presetting the car seat, minors, and even radio stations to the users preferences when the user (and the user's associated RFID tag) moves within a certain, prescribed distance of the vehicle.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### Example 1

A customer in a warehouse-type home merchandizing retail setting (e.g., The Home Depot®) desires to purchase a drain tool (e.g., the POWERSPIN™ hand-held drain maintenance tool) for use in a home plumbing repair project. These specific articles are displayed in a merchandiser of the type described herein and illustrated in FIG. 3A. While the merchandiser sits static, the display screen associated with the merchandiser displays marketing messages in order to create noise in the display environment, so as to attract customers to the product display. The customer approaches the merchandiser and its interactive display of drain maintenance tools, and selects one of the drain tools off the display rack within the merchandiser. Unbeknownst to the customer, the product packaging contains an ALIEN ALN 9440® RFID tag (Alien Technologies Corp.) which is continuously pulsing radio frequency energy for the purpose of designating its three-dimensional location within the merchandising bay of the merchandising rack.

Once the customer makes the selection of the drain tool from the display rack, the tag recognition system activates. In selecting the product, the movement in three-dimensional space of the drain tool is detected as it breaks the boundaries of the “read curtain” by an inconspicuously mounted RF reader/detector, which in turn starts to the count the reads on the tag, and transmits this product data to a CPU attached (directly or wirelessly) to the reader. The CPU attached to the reader then cues its next series of activities, such as displaying additional product information, message, and product comparison information to the customer using any suitable display means (e.g., a video monitor) mounted on or near the merchandising rack. The display means then displays information about the product, such as the product description, applications and uses for the product, and a picture of the chosen object. Other information presented to the customer includes printable instructions for proper use of the chosen object, items related to the chosen object that the customer can consider for purchase (e.g., other plumbing tools, such as the RIGID™ K-3 Toilet Auger), and information concerning the location (within the store), accurate availability (how many are in stock), and cost of such related items.

Upon removal of the drain tool from the pre-defined, three-dimensional “read zone”, the RF reader/detector also transmits data to the warehouse, and even the supplier, informing the appropriate databases of the ID Number (e.g., TagID) of the product purchased, the SKU Number of the product purchases, an updated number count on the number of the particular product remaining, and/or whether or not the shelf is empty and product should be automatically re-ordered.

Other and further embodiments utilizing one or more aspects of the inventions described above can be devised without departing from the spirit of Applicant's invention. For example, the location and type of display and CPU system can be varied as appropriate for the particular marketing environment. Further, the various methods and embodiments of the present merchandising and product shelf monitoring approaches in retail environments using RFID technology can be included in combination with each other to produce variations of the disclosed methods and embodiments. Discussion of singular elements can include plural elements and vice-versa.

In addition, the order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described herein in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A system for interactive marketing of a product in a retail environment, the system comprising:
a merchandise display comprising a back, a side, and a top, and a substantially open front region;
an RFID tag associated with an object located within the merchandise display;
an RFID reader for receiving signals from the RFID tag with a read zone;
a display means for displaying information related to the object; and
a computer programmed to cause the display means to present information associated with the object when the associated RFID tag is read by the RFID reader.

2. The system of claim 1, further including a wire mesh for preventing the read zone from extending into the merchandize display, such that the RFID tag is read when it is removed from the merchandize display.

3. The system of claim 1, wherein the information includes information concerning proper use of the object.

4. The system of claim 1, wherein the information includes information concerning uses for the object.

5. The system of claim 1, wherein the information includes information concerning one or more items related to the chosen object.

6. The system of claim 5, wherein the information includes information concerning where the items related to the chosen object may be found in a store.

7. The system of claim 5, wherein the information includes information concerning availability of the items related to the chosen object.

8. The system of claim 5, wherein the information includes information concerning cost of the items related to the chosen object.

9. The system of claim 1, wherein the information includes printable instructions.

10. The system of claim 1, wherein the computer is programmed to cause the display means to present the information when the RFID tag enters the read zone.

11. A system for interactive marketing of a product in a retail environment, the system comprising:
a merchandise display comprising a back, a side, and a top, and a substantially open front region;
an RFID tag associated with each of a plurality of objects located within the merchandise display;
an RFID reader for receiving signals from the RFID tags and determining each RFID tag's position within a read zone;
a display means for displaying information related to each object; and
a computer programmed to cause the display means to present information associated with each object when the RFID tag associated with that object is moved.

12. The system of claim 11, wherein the computer is further programmed to provide an updated count of a number of objects in the display, when any of the objects are removed from the display.

13. The system of claim 11, wherein the information includes information concerning proper use of the object.

14. The system of claim 11, wherein the information includes information concerning uses for the object.

15. The system of claim 11, wherein the information includes information concerning one or more items related to the chosen object.

16. The system of claim 15, wherein the information includes information concerning where the items related to the chosen object may be found in a store.

17. The system of claim 15, wherein the information includes information concerning availability of the items related to the chosen object.

18. The system of claim 15, wherein the information includes information concerning cost of the items related to the chosen object.

19. The system of claim 11, wherein the information includes printable instructions.
